(19) United States
(12) Patent Application Publication
(10) Pub. No.: US 2010/0277420 A1
(43) Pub. Date: Nov. 4, 2010

(54) Hand Held Electronic Device and Method of Performing a Dual Sided Gesture

(75) Inventors: Michael L. Charlier, Palatine, IL (US); Thomas E. Gitzinger, Libertyville, IL (US); Jeong J. Ma, Long Grove, IL (US); Tom R. Schirtzinger, Fontana, WI (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/433,253

(22) Filed: Apr. 30, 2009

(51) Int. Cl. G06F 3/041

(52) U.S. Cl. 345/173

(57) ABSTRACT

A method and hand held electronic device are provided for performing a dual sided gesture on respective touch sensitive surfaces of a hand held electronic device. The method includes displaying an object on a display screen of the hand held electronic device, that is viewable from at least one side of the hand held electronic device. A virtual center of gravity associated with the displayed object is then defined. Simultaneous gestures are then received tracking the position and movement of an end of a pointer on each of a pair of respective surfaces of the hand held electronic device, each surface having a corresponding touch sensitive input. The location and movement of each gesture is then compared relative to the defined virtual center of gravity, and the displayed object is repositioned in response to the location and movement of each gesture relative to the defined virtual center of gravity.

### FIELD OF THE INVENTION

The present invention relates generally to a device and a method for supplying a user input to a hand-held device, and more particularly, to dual sided gestures performed relative to a device adapted for receiving touch input via multiple sides of the device.

### BACKGROUND OF THE INVENTION

With the trend for smaller hand held devices, such as cell phones, and the need to continue to generally reserve surface space for the positioning of interactive elements for purposes of enabling the user to interact with the device, the use of touch sensitive displays, which enable a device to visually convey information to a user, as well as enable a user to interact contextually with displayed object and otherwise provide user input to the device is increasingly being used. Touch sensitive displays merge input and output functions for some portable electronic devices, which in absence of the use of a similar and/or alternative form of input/output merging capability might otherwise require their own dedicated portions of the device surface. For example, many devices have historically incorporated a separate display and keypad on distinct portions of the external surface of the device.

However, some device designs have been able to extend the size of the display by extending it to include the surface space of the device that might otherwise have been separately dedicated to the location of a keypad. In some such instances, keypad-like input capabilities have been provided and/or maintained through the use of touch sensitive capabilities built into the extended display. One of the benefits of such a merger is the ability to dynamically change the size, shape and arrangement of keys, where each key can correspond to a subset of the surface space of the touch sensitive display associated therewith. Furthermore, each key can be accompanied by a visual indication, generally, through the integrated display, and more specifically the portions of the display that are currently active for providing each currently permissible form of user key selection and/or the immediately adjacent portions.

However one of the difficulties associated with touch screen displays includes the possibility that portions of the display become obstructed by one's fingers or hands in circumstances during which the user is simultaneously attempting to provide user input through the touch sensitive display interface, while one is attempting to view the information being presented via the display. Furthermore, interaction with the display with one's fingers can often leave smudges, which while they do not generally affect the operation of the device, can sometimes affect the appearance of the device, and may also impact the perceived image quality.

Consequently, some devices have incorporated touch sensitive surfaces that are located on the back side of the device, which are intended for use by the user to interact with and/or select items, which are being displayed on the front side of the device. However sometimes it can be less than clear which location on the front facing display corresponds to particular position being currently touched on the back of the device.

The use of a touch sensitive surface not only allows for the location of an interacting object, such as a pointer, to be identified by the device, but the movement of the interacting object can be similarly tracked as a function of time as the interacting object moves across the touch surface, in many instances. In this way, it may be possible to detect gestures, which can be mapped to and used to distinguish a particular type of function that may be desired to be implemented relative to the device and/or one or more selected objects. In some instances, multi-pointer gestures have been used to more intuitively identify some desired functions, such as the two finger pinching or spreading motion, which has sometimes been used to zoom in and zoom out.

However, multi-pointer gestures have generally been defined relative to a single touch sensitive input surface. Further, when one holds a device it is common for one's hand to wrap around the side of the device from the back of the device to the front of the device. Correspondingly, the present inventors have recognized that it would be beneficial to enable interactions with multiple sides of the device to be tracked for purposes of defining interactive gestures including interactive gestures involving multiple pointers, and for purposes of detecting the same. In this way some gestures can be integrated and or made more compatible with an action which is similarly intended to grip or hold an object. Still further, the present inventors have recognized that it would be beneficial if the user could more readily correlate a particular point associated with the back of the device, with which the user is currently interacting, and the corresponding point or object being displayed on the screen, which is visible via the front of the device.

### SUMMARY OF THE INVENTION

The present invention provides a method of performing a dual sided gesture on respective touch sensitive surfaces of a hand held electronic device. The method includes displaying an object on a display screen of the hand held electronic device, that is viewable from at least one side of the hand held electronic device. A virtual center of gravity associated with the displayed object is then defined. Simultaneous gestures are then received tracking the position and movement of an end of a pointer on each of a pair of respective surfaces of the hand held electronic device, each surface having a corresponding touch sensitive input. The location and movement of each gesture is then compared relative to the defined virtual center of gravity, and the displayed object is repositioned in response to the location and movement of each gesture relative to the defined virtual center of gravity.

In at least one embodiment, a detected difference in the direction of movement between the two gestures relative to the virtual center of gravity will produce a rotation in the object on the display screen in a direction consistent with detected difference from a perspective of a primary viewing side of the display screen.

In at least a further embodiment, the respective surfaces include a primary side intended to be facing toward the primary user during usage and a secondary side intended to be facing away from the primary user during usage, and the method further includes receiving a gesture tracking the position and movement of an end of a pointer on only the surface corresponding to the secondary side of the hand held electronic device, that has a corresponding touch sensitive input. A display position of the displayed object is then moved laterally relative to the display screen, an amount corresponding to the detected distance and direction of movement of the end of the pointer relative to the surface of the secondary side of the hand held electronic device.

The present invention further provides a method of performing a dual sided gesture on respective touch sensitive surfaces of a hand held electronic device. The method includes displaying an object on a display screen, where the display screen includes multiple layered transparent displays including at least a primary side display, which is more proximate a primary viewing side, which is intended to be facing toward a primary user during usage, and a secondary side display, which is less proximate the primary viewing side, upon one of which the object is displayed. The object being displayed upon one of the primary side display and the secondary side display is then selected. Upon selection of an object being displayed upon the primary side display, touching the secondary side touch sensitive surface will result in the display of the object being moved from the primary side display to the secondary side display, and upon selection of an object being displayed upon the secondary side display, touching the primary side touch sensitive surface will result in the display of the object being moved from the secondary side display to the primary side display.

The present invention still further provides a hand held electronic device. The hand held electronic device includes a display screen for displaying an object viewable from at least one side of the hand held electronic device. The hand held electronic device further includes a pair of touch sensitive interfaces corresponding to opposite sides of the hand held electronic device adapted for tracking the position and movement of an end of a pointer on each of the respective touch sensitive interfaces. The hand held electronic device still further includes a user input controller. The user input controller has an object selection module for selecting an object being displayed on the display screen, and an object management module for detecting one or more gestures detected via one or more of the pair of touch sensitive interfaces, and repositioning a selected object based upon the one or more gestures, where the object management module is adapted for defining a virtual center of gravity for a selected object, detecting a simultaneous gesture on each of the pair of touch sensitive interfaces, and repositioning the displayed object in response to the location and movement of each gesture relative to the defined virtual center of gravity.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a plan view of an exemplary portable electronic device incorporating a dual sided transparent display module, in accordance with at least one embodiment of the present invention;

FIG. 2 is a further plan view of the exemplary hand held portable electronic device, illustrated in FIG. 1, further highlighting an example of user interaction with the device;

FIG. 3 is an isometric view of a multi layer stack up for a dual sided display module for use in a hand held electronic device, in accordance with at least some embodiments of the present invention;

FIG. 4 is a partial top view of a hand held electronic device having dual touch sensitive surfaces, which highlights a user interaction with the touch surfaces, and a corresponding interaction with a displayed element;

FIG. 5 is a further partial top view of a hand held electronic device having dual touch sensitive surfaces, which highlights a user interaction with the touch surfaces, and a corresponding interaction with a displayed element;

FIG. 6 is a partial top view of a hand held electronic device having dual touch sensitive surfaces, which highlights an exemplary manner of determining a virtual center of gravity;

FIG. 7 is a further partial top view of a hand held electronic device having dual touch sensitive surfaces, which highlights an exemplary manner of determining a virtual center of gravity;

FIG. 8 is a still further partial top view of a hand held electronic device having dual touch sensitive surfaces, which highlights a user interaction with the touch surfaces, and a corresponding interaction with a displayed element;

FIG. 9 is a partial front plan view showing some or all of a grouping of a plurality of elements, in the form of a linear list from which an element can be selected;

FIG. 10 is a front perspective view showing some or all of a grouping of a plurality of elements, in the form of a circular list from which an element can be selected;

FIG. 11 is a partial top view of a hand held electronic device having dual touch sensitive surfaces, which highlights a user interaction with the touch surfaces, and a corresponding interaction with a displayed element relative to multiple layers of displays, which overlap;

FIG. 12 is a further partial top view of a hand held electronic device having dual touch sensitive surfaces, which highlights a user interaction with the touch surfaces, and a corresponding interaction with a displayed element relative to multiple layers of displays, which overlap;

FIG. 13 is a block diagram of a hand held electronic device, in accordance with at least one aspect of the present invention;

FIG. 14 is a flow diagram of a method of performing a dual sided gesture on a hand held electronic device, in accordance with at least one embodiment of the present invention; and

FIG. 15 is a further flow diagram of a method of performing a dual sided gesture on a hand held electronic device, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated. Furthermore, while the various figures are intended to illustrate the various claimed aspects of the present invention, in doing so, the elements are not necessarily intended to be drawn to scale. In other word, the size, shape and dimensions of some layers, features, components and/or regions for purposes of clarity or for purposes of better describing or illustrating the concepts intended to be conveyed may be exaggerated and/or emphasized relative to other illustrated elements.

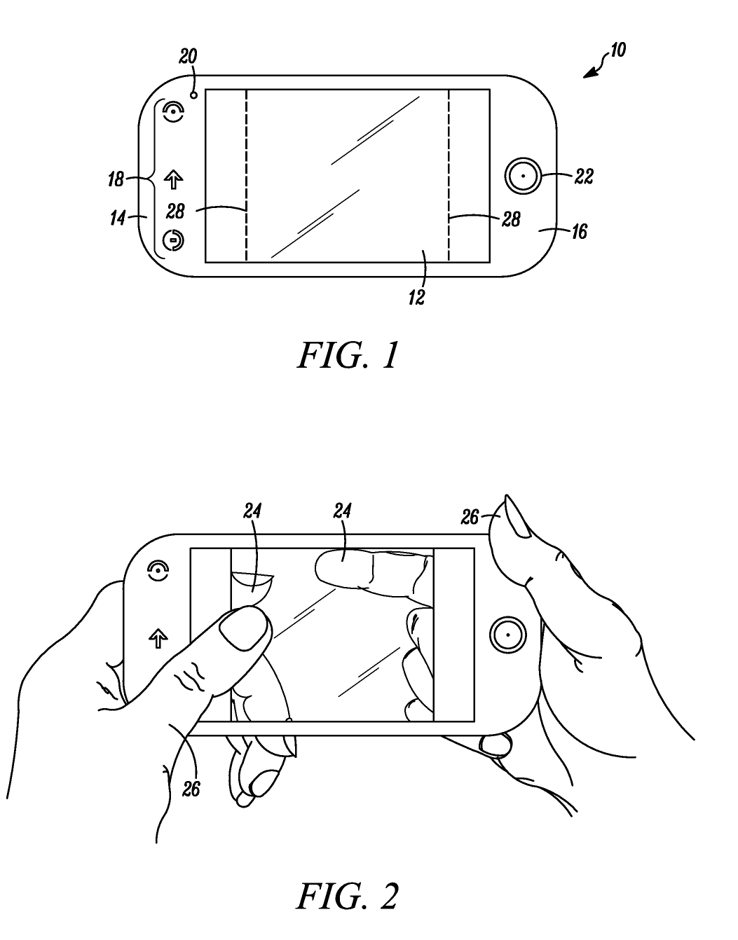

FIG. 1 illustrates a plan view of an exemplary portable electronic device 10 incorporating a dual sided transparent display module 12, in accordance with at least one embodiment of the present invention. In the illustrated embodiment, the display module 12 is generally centrally located relative to the front facing of the device 10, and generally provides a viewing characteristic and arrangement relative to the other features of the device 10, that enables one to see through the device 10 in at least portions of the area corresponding to the display, in a manner, which is at least somewhat similar to a window. While the display module 12 has a front surface and a back surface, as well as internal structure, the structure is largely comprised of transparent materials, partially transparent, or materials that can be selectively transparent, which enables one to see through the structure in order to see objects located on the other side of the device 10 and/or display in at least some operational modes, as well as view elements imaged by the display module 12 including in at least some instances from both sides of the display module 12.

In the particular embodiment illustrated, the front portion of the display module 12 extends across a significant portion of the front facing of the device 10 with the exception of areas 14, 16 to each of the left and the right of the display. For example to the left of the display, an area 14 incorporating a set of dedicated keys 18 is illustrated. This area 14 might correspond to the bottom of the device 10 when the device 10 is oriented in support of voice communications and can include a microphone 20, where the device might be positioned proximate the user's mouth for picking up voice signals via the microphone 20. Alternatively, the area 16 to the right of the display, which might correspond to the top of the device when oriented in support of voice communications, could include a speaker 22 for positioning proximate the user's ear for conveying reproduced audio signals, which could be encoded as part of a signal received by the device 10.

As part of the display module 12, surfaces can be incorporated coinciding with each of the front side surface of the device 10 and the back side surface of the device 10 from which visual elements can be imaged so as to be viewable by a user. The surfaces of the display module 12 coinciding with each of the front side surface of the device 10 and the back side surface of the device 10 can also respectively include a touch sensitive input array, that can be used to track the location and movement of a pointer, for example a user's finger 24 or thumb 26, as illustrated in FIG. 2, and/or possibly a stylus or other pointer type device positioned proximate one or both surfaces of the device. The tracking of the location and the movement of a pointer enables the device to detect prearranged patterns or positions, thereby enabling the user to potentially interact with elements being displayed by one or more displays incorporated as part of the display module 12, and/or trigger the selection or start of one or more functions that can then be executed by the device 10.

By incorporating a touch sensitive surface on both sides of the device, the user can interact with the device by touching one or both surfaces. This enables a user to select displayed elements, and associate a desired command or interactive effect which can be used to select and/or manipulate a particular desired displayed element, or more generically a function relative to the device, itself. The interaction with a displayed element or the device 10 can be achieved through interactions with the touch sensitive surfaces of the display module 12 from either the front or the back. With respect to some gestures or interactions with the device 10 or a displayed element, in at least some instances, the effect may be the same regardless as to whether the gesture or interaction is performed relative to the front surface or back surface of the device 10. In other instances, the particular effect associated with a particular gesture or interaction may be different depending upon the side from which the gesture is performed and correspondingly detected. In still further instances, a gesture or interaction with the device 10 can incorporate a selected positioning and movement that tracks multiple separate pointer positions on the same or alternative surfaces. In this way various different gestures can be defined, so as to enable multiple types of interactions to be performed, relative to the display module or a selected displayed element.

Given the transparent nature of the display module 12, and the fact that the display module in some instances may be intended to be seen through from one side to the other, and can accommodate the display of image elements that can be seen through portions of the device and may in some circumstances be viewed from both sides of the device, the placement of other non-display related device elements, such as communication and control circuitry, processing circuitry and energy storage elements may be somewhat restricted. More specifically device elements that are not transparent, partially transparent, and/or selectively transparent, generally may not want to be placed in an area where it is intended for the user to be able to see through the corresponding portions of the display module, otherwise they could potentially be seen and/or could obstruct the ability of the user to see through the display module and the associated portions of the device. Consequently, many of the circuit elements, that are not associated with the transparent portions of the display, are placed in the areas that do not allow for the more window-like observations through the device.

In at least some embodiments, the size of the viewable display portion of the display module on one side of the device and correspondingly the display module may be of a different size than the viewable display portion of the display module on the other side of the device. In such an instance, the viewing side surface (front or back) of the display module 12 that is larger will likely extend into areas that do not have potentially transparent see through window-like characteristics. Such areas are similarly possible in instances where one window is not necessarily larger than the other, but in instances where the two viewing sides of the display module 12 are laterally offset to produce a potentially similar affect for each of the respective viewing sides.

One of the effects of such an area for one of the viewing sides of the display module 12, which does not have a respective see through arrangement, is the ability to have portions of the display which is viewable against an opaque background, and in which the information that is being displayed for such an area for the particular side is not viewable from the other side. Such non-transparent regions can be sized and arranged to increase the overall size of the viewable display, relative to a particular side, while providing some transparency for seeing through the device 10, which can then be used to better confirm the position of a pointer interacting with the touch sensitive back surface of the device 10 and display module 12. Furthermore, the inclusion of the non-transparent regions within a given display area allows for an increase in the size of the areas, such as the left side area 14 and the right side area 16 described in connection with FIG. 1, that can be used to place non transparent device elements, such as the ones noted above, in areas which do not interfere with the more window-like effect of the transparent portions of the transparent display module 12.

Dashed lines 28, shown in FIG. 1, illustrate one potential boundary line for a smaller viewing portion associated with the back side surface of the device, which in turn limit the portions of the viewable area of the display associated with the front side surface of the device, through which the user can see in window-like fashion. FIG. 2 illustrates the potential impact such a smaller viewing area might have on the ability to see objects, such as pointing elements, that might be at least partially visible through the device.

However, while the an exemplary hand held device 10 having a transparent display 12 has been shown and described, the gestures defined below in connection with the present application, can also be performed on devices having touch sensitive surfaces respectively associated with each of a pair of surfaces of the device with which the user can interact, regardless as to whether some or all of the display module 12 is transparent or not, and/or whether the display module 12 of the device 10 has window-like capabilities.

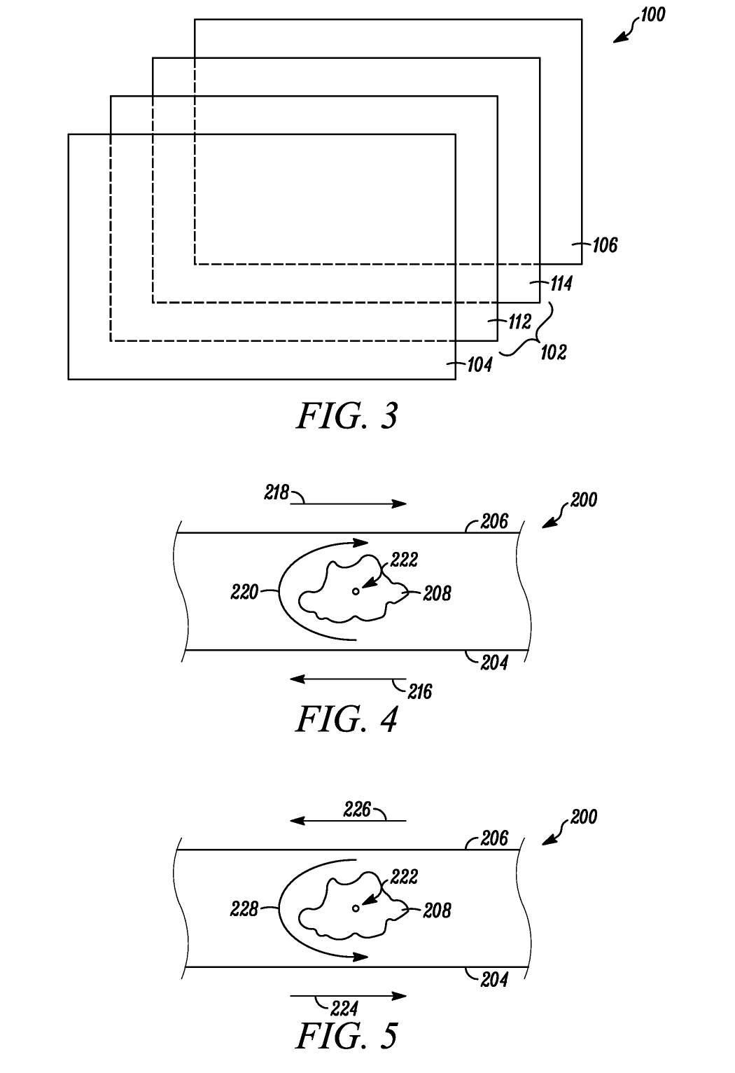

FIG. 3 illustrates an isometric view of a multi layer stack up for a dual sided display module 100 for use in a hand held electronic device, in accordance with at least some embodiments of the present invention. The dual sided display module 100 includes a display screen 102, which may include one or more layered displays. In the particular example illustrated, the display screen 102 includes a pair of displays, a primary side display 112 and a secondary side display 114 upon which one or more visual elements that can be perceived by the user are intended to be displayed. The primary side display 112 is generally more proximate a primary viewing side, which is intended to be facing toward a primary user during usage. The secondary side display 114, is generally less proximate the primary viewing side.

Where multiple displays are used, the general intent in some instances is to enable the possibility that elements displayed on the respective displays to be simultaneously viewable by a user in at least some operating modes or configurations. In such instances, the display elements might be viewed as being superimposed upon one another, which might give the display the appearance of some having some depth. In other instances the display might have discreet planes that are distinguishable by the user, whereby the user interaction with the displayed elements may be dependent upon the particular display upon which the corresponding element is being displayed. For example one of the displays may be associated with a foreground, and another one of the displays may be associated with a background.

In at least some instances, the displays are arranged as and/or include a plurality of separately addressable display elements, which can be separately actuated to produce a varied visual effect. In some of these instances a plurality of separately addressable elements, sometimes referred to as pixels, are arranged in a substantially planer two dimensional grid-like pattern. The pixels themselves often involve individual elements that can support at least a pair of states, that produce at least two different observable visual effects, such as a light being on or off, or an element being transparent or opaque. The visual state of multiple pixel elements can be controlled, and when viewed together can produce different visual images and effects.

A couple of examples of suitable display technologies that might be used with the present application includes an example of a non-light emitting display, such as liquid crystal type displays, or an example of a light emitting display, such as light emitting diode type displays, each of which can include individually addressable elements (i.e. pixels), that can be used to form the visual elements to be displayed. In at least one instance an organic light emitting diode display can be used. The advantage to using a light emitting type display is that a separate light source need not be used, such as backlighting or the use of a reflective back surface, for producing a user perceivable image, at least some of which would be difficult to incorporate in the context of a transparent window-like display.

On one side of the display screen 102 is a primary side touch sensitive interface 104, corresponding to a primary side of a device. On the other side of the display screen 102 is a secondary side touch sensitive interface 106, corresponding to a secondary side of the device. However, the terms primary and secondary are relative and could easily be interchanged, but together generally refer to the elements corresponding to opposite sides of the device. It is further possible that dual sided display module 100 could include still further elements, but the present description has focused on these elements as they help serve as the basis and are later referenced in connection with the discussion of some of the further features later described in the present application.

Each of the primary side touch sensitive interface 104 and the secondary side touch sensitive interface 106 can be used to detect the interaction and movement of the pointer relative to a respective surface of the device. The touch sensitive interfaces 104 and 106 can each make use of several different types of touch tracking technologies, including touch technology that is capacitive and/or resistive in nature. However depending upon the type of technology selected it may be capable of detecting different types of pointers, as well as different types of interactions with the touch sensitive interfaces 104 and 106.

In the case of capacitive-type touch sensitive interfaces, the interface can produce a detection field that can extend through a dielectric substrate, such as glass or plastic, and can be used to detect the proximity of a conductive mass that enters or disturbs the one or more fields often arranged as an array of elements in a grid-like pattern. Generally, a touch sensitive interface 104 or 106 of this type will produce a plurality of electric fields, associated with a plurality of capacitive sensors which can be sensed to determine the presence and the current location of an encroaching conductive mass that has interacted with the respective fields. Such touch sensors are sometimes referred to as proximity touch sensor arrays.

In the case of resistive-type touch sensitive interfaces, the interface includes a plurality of points often arranged as an array of elements positioned in a grid-like pattern whereby the amount of pressure being applied can be detected. In such an instance an array of elements in which the resistance will vary dependent upon the amount of force applied can be used to not only detect the presence and location of a touch, but at the same time provide an estimate to the amount of force being applied. Such touch sensors are sometimes referred to as force sensing touch sensor arrays. Because the force sensing is local relative to each detection point, a form of direct and discreet contact with the array of touch sensors may need to be possible, which often limits the opportunities for the presence of and/or the type of intervening layers.

One skilled in the art will readily recognize that there exists still further types of touch detection technologies, each having their own set of limitations and features, which can be used without departing from the teachings of the present application.

FIG. 4 illustrates a partial top view of a hand held electronic device 200 having dual touch sensitive surfaces 204 and 206, which highlights a user interaction with the touch surfaces, and a corresponding interaction with a displayed element 208. More specifically, the hand held electronic device 200 includes a primary side touch sensitive surface or interface 204 and the secondary side touch sensitive surface or interface 206. While a displayed element 208 is illustrated, it does not necessarily reflect the actual image being displayed, but alternatively represents an object modeled in 3-D space, but represented on the display in 2-D space, such that when the modeled object is manipulated (i.e. rotated and/or moved), it impacts the visual representation of the object in the displayed 2-D space.

In the illustrated embodiment, a pair of arrows 216 and 218 represents a user interaction, in the form of a multiple gestures simultaneously and respectively applied to multiple touch sensitive surfaces 204 and 206. In the particular embodiment illustrated, the pair of arrows 216 and 218 indicates a tracking of movement on respective touch sensitive surfaces 204 and 206, which each move in opposite directions. Such a respective movement on each of the surfaces 204 and 206 is defined to produce a rotation of the modeled object 208, which in turn results in the visual representation of the object in 2-D space from a different angle as if the modeled object 208 had been rotated 220 about a virtual center of gravity 222.

FIG. 5 illustrates a further partial top view of a hand held electronic device 200 having dual touch sensitive surfaces 204 and 206, which highlights a user interaction with the touch surfaces, and a corresponding interaction with a displayed element 208. The view in FIG. 5 is similar to the view in FIG. 4, which as noted above includes a representation of a modeled object 208, and a representation of an associated interaction with a pair of respective touch sensitive surfaces, which could be used to select the rotation of the virtual 3-D modeled object 208, that would in turn impact the resulting 2-D visual representation of the modeled object 208.

However the view illustrated in FIG. 5 differs from the view illustrated in FIG. 4, principally in the direction of the multiple simultaneous gestures represented by a pair of arrows 224 and 226, and the corresponding rotation 228 of the modeled object 208. By reversing the direction of the simultaneous gestures that are applied to their respective touch sensitive surfaces 204 and 206, the corresponding rotation of the modeled object 208 is reversed, which in turn affects the visual representation of the object conveyed on the 2-D surface of the display screen.

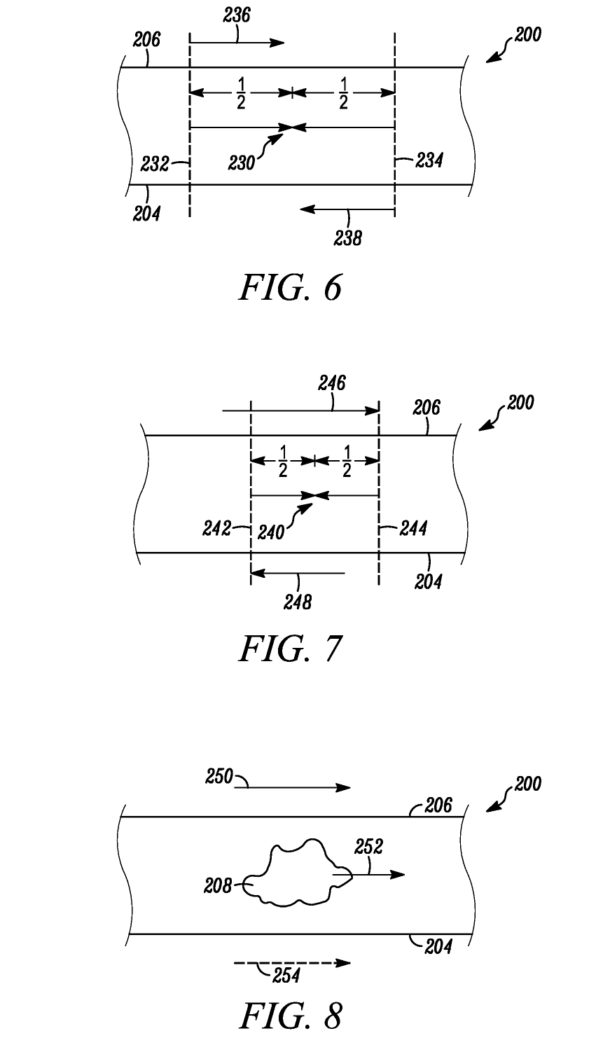

FIGS. 6 and 7 illustrate a partial top views of a hand held electronic device 200 having dual touch sensitive surfaces 204 and 206, which highlights an exemplary manner of determining a virtual center of gravity 222. In defining a rotation, there are several parameters which can affect the result. Among the relevant parameters are the direction and the amount of rotation. A further parameter includes the point about which the elements are being rotated. In at least some embodiment of the present invention, the point about which the elements are being rotated is described as the virtual center of gravity 222, even though the point about which the visual representation of displayed objects are being rotated may not even correspond to any of the objects being visually represented, let alone correspond to a point that might be co-located with any of the visually represented objects that might be viewed as the center of gravity for the object. Center of gravity serves to provide a point of reference about which the rotation of the affected objects will occur, with the amount and the direction of the rotation determined by the detected gestures.

In some instances the center of gravity might be determined in reference to and might be based upon the dimensions of the display screen. In some of these instances, the center of gravity might coincide with the center point of the display, where the center point for purposes of determining the center of gravity may be defined relative to the size and shape of the display in one or both of the generally two dimensions across which the display extends. In other instances, the virtual center of gravity, similar to the direction and the amount of rotation, may be defined by one or more aspects of the detected gestures. For example, the virtual center of gravity, as illustrated in FIG. 6 could be based upon a mid-point 230 of the starting points 232 and 234 of each of the respective simultaneously detected gestures 236 and 238. A further alternative example is illustrated in FIG. 7, where the virtual center of gravity might be based upon a mid-point 240 of the ending points 242 and 244 of each of the respective simultaneously detected gestures 246 and 248. One skilled in the art will recognize that still further examples of different approaches for defining a virtual center of gravity for purposes of defining the point about which a rotation will occur are possible without departing from the teachings of the present invention.

FIG. 8 illustrates a still further partial top view of a hand held electronic device 200 having dual touch sensitive surfaces 204 and 206, which highlights a user interaction with the touch surfaces, and a corresponding interaction with a displayed element 208. More specifically, the user interaction includes a swiping gesture across the secondary or back touch sensitive surface 206, represented by arrow 250, which is adapted to produce a lateral movement 252 or panning of the object relative to the display area. The swiping gesture across the secondary touch sensitive surface 206, in some instances, could be accompanied by a swiping motion, represented by arrow 254, in a similar direction across the primary touch sensitive surface 204.

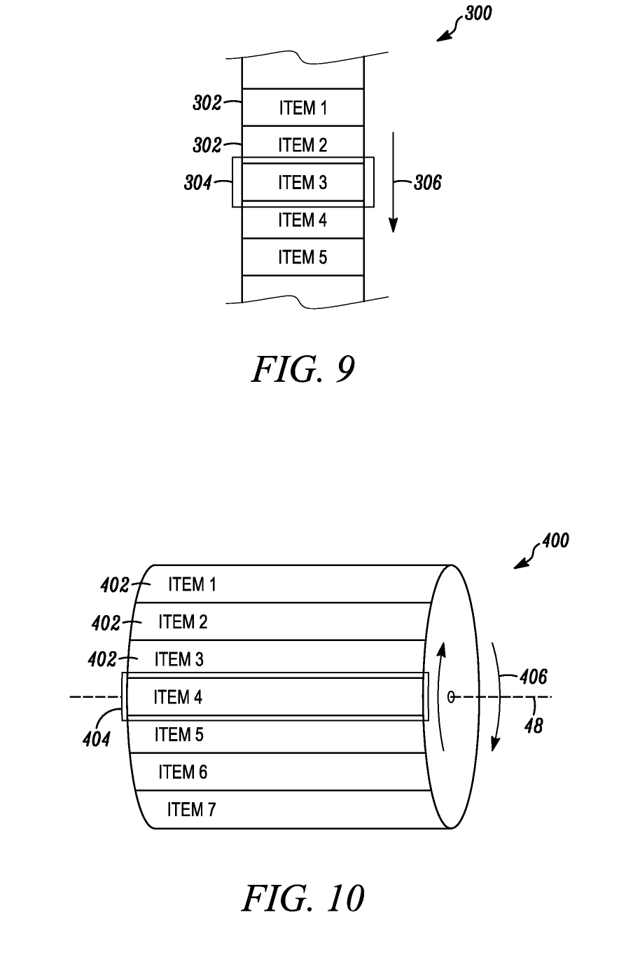

In addition to being able to manipulate the visual representation of physical objects, the same interactive techniques could be applied to groupings or lists of elements, such as a list of items in a menu. FIG. 9 illustrates a partial front plan view showing some or all of a grouping of a plurality of elements 302, in the form of a linear list 300 from which an element can be selected. In accordance with the illustrated embodiment, a point of prominence 304 is illustrated, which coincides with one of the items or elements in the list.

A gesture, such as a swiping motion represented by arrow 306, can be detected via the secondary side 206 of the device 200, which in turn can produce a movement of the list of elements 300 relative to the point of prominence 304, in a direction consistent with the swiping motion. In such an instance the detected motion might produce a movement of the elements in the list 300 such that the element or item coinciding with the point of prominence 304, transitions from “item 3”, as illustrated in the figure, to “item 2” and then possibly “item 1” depending upon the length or velocity of the movement corresponding to the gesture. Longer gestures or higher velocity gestures might result in a greater movement in the list 300, such that an item that is further away from the point of prominence 304 prior to the gesture being made, is moved so as to coincide with the point of prominence 304 after the gesture is made.

The point of prominence 304 might include an outline or box, which can be used to highlight the particular point. Additionally and/or alternatively, the item coinciding with the point of prominence may have text which is otherwise enlarged or highlighted. After the position of the desired item coincides with the point of prominence, a tap on the primary touch sensitive surface 204 could result in a selection of that item. In some instances, the corresponding tap could be triggered by a tap coinciding and/or positioned proximate the point of prominence.

FIG. 10 illustrates a front perspective view showing some or all of a grouping 400 of a plurality of elements 402, in the form of a circular list from which an element can be selected. As illustrated, a point of prominence 404 currently coincides with the element designated “item 4” from the list of elements. However, the circular list differs from the linear list, illustrated in FIG. 9, in so far as a gesture applied to the secondary or back surface of the device may conceptually result in an expected migration of the listed elements relative to the point of prominence, that moves in a different direction. That is because a downward force applied to the back of the circular list, would produce an upward movement in the front of the circular list, assuming the circular list were to rotate about a fixed horizontal axis 408. Consequently, a downward swipe, represented by arrow 406, would result in the list of elements sequencing through the point of prominence including “item 5”, “item 6”, “item 7”, etc., dependent upon length and/or the velocity of the downward gesture. Alternatively, in order to produce a counter movement in the list of elements relative to the point of prominence, a gesture including a movement in the opposite direction could be applied.

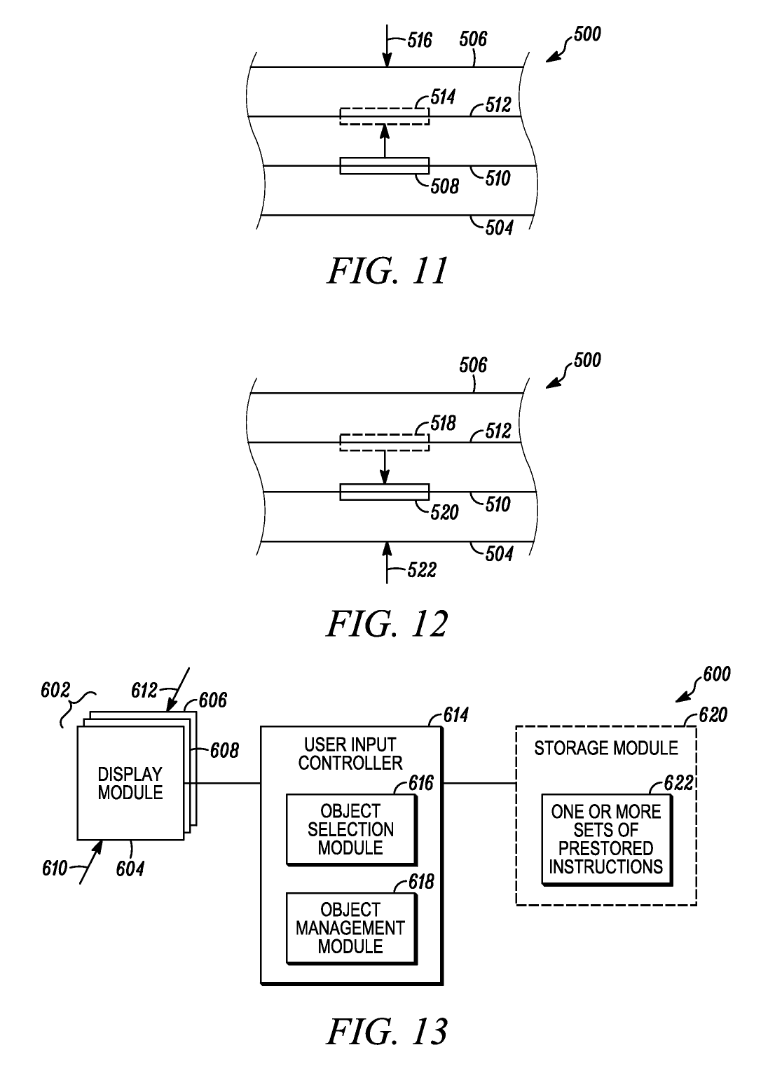

FIGS. 11 and 12 illustrate a partial top views of a hand held electronic device 500 having dual touch sensitive surfaces 504 and 506, which highlights a user interaction with the touch surfaces, and a corresponding interaction with a displayed element relative to multiple layers of displays including a primary side display 510 and a secondary side display 512, which overlap at least partially. In the context of the embodiment illustrated in FIG. 11, the solid outline of a displayed element 508 associated with the primary side display 510 is intended to represent a highlighted or selected item. When such an item is selected, a touching 516 of the secondary side touch sensitive surface 506 of the device can be used to cause the selected item 508 to transition from being presented on the primary side display 510 to an item 514 being presented on the secondary side display 512. Alternatively, FIG. 12 illustrates a selected or highlighted item 518, that is initially associated with the secondary side display 512, which in turn can transition from being displayed on the secondary side display 512 to an item 520 being displayed on the primary side display 510, when the primary side touch sensitive surface 522 is touched 522 with a pointer.

In some instances, touching and/or user interaction with the primary side touch sensitive surface 504 or the secondary side touch sensitive surface 506, will result in displayed element being transitioned between different ones of multiple stacked displays. In other instances, the intensity of the elements being displayed on a particular one of the different displays may be affected. In any event, an ability to interact with multiple different touch sensitive surfaces can add another level of distinction to gestures that might otherwise be indistinguishable.

As a still further example, the particular touch sensitive surface with which the user interacts can be used to differentiate which one of multiple stacked objects with which the user is interacting. For example, a stack of elements would include individual elements arranged in a particular order, where interacting with the back of the device might select and manipulate items from the bottom of the stack, and interacting with the front of the device might select and manipulate items from the top of the stack.

FIG. 13 illustrates a block diagram of a hand held electronic device 600, in accordance with at least one aspect of the present invention. The hand held electronic device 600 includes a display module 604 having a display screen 608, a primary side touch sensitive interface 604 or layer, and a secondary side touch sensitive interface 606 or layer. The display screen 608 can include one or more distinct display layers, at least some of which may overlap in a direction perpendicular to an image plane of each of the displays. In at least some instances, the one or more distinct display layers can include transparent displays, that are viewable from opposite sides of the hand held electronic device 600. The primary and secondary side touch sensitive interfaces 604 and 606 are each adapted to receiving and detecting respective touch interactions 610 and 612 at the front and back side surfaces of the device 600.

The hand held electronic device 600 further includes a user input controller 614, which can include an object selection module 616 and an object management module 618. The object selection module 616 is adapted for selecting an object being displayed on the display screen 608. The object management module 618 is adapted for detecting one or more gestures detected via one or more of the pair of touch sensitive interfaces 604 and 606, and repositioning a selected object based upon the one or more detected gestures. In support of such a repositioning, the object management module 618 can define a virtual center of gravity 222 for a selected object or a group of selected objects, can detect simultaneous gestures on each of the pair of touch sensitive surfaces 604 and 606, and can reposition the displayed object in response to the location and movement of each gesture relative to the defined virtual center of gravity 222.

In some embodiments, the user input controller 614 could be implemented in the form of a microprocessor, which is adapted to execute one or more sets of prestored instructions 622, which may be used to form at least part of one or more controller modules 616 and 618. The one or more sets of prestored instructions 622 may be stored in a storage module 620, which is either integrated as part of the controller or is coupled to the controller 614. The storage element 620 can include one or more forms of volatile and/or non-volatile memory, including conventional ROM, EPROM, RAM, or EEPROM. The storage element 414 may still further incorporate one or more forms of auxiliary storage, which is either fixed or removable, such as a harddrive or a floppydrive. One skilled in the art will still further appreciate, that still other further forms of memory could be used without departing from the teachings of the present invention. In the same or other instances, the controller 614 may additionally or alternatively incorporate state machines and/or logic circuitry, which can be used to implement at least partially, some of modules and their corresponding functionality.

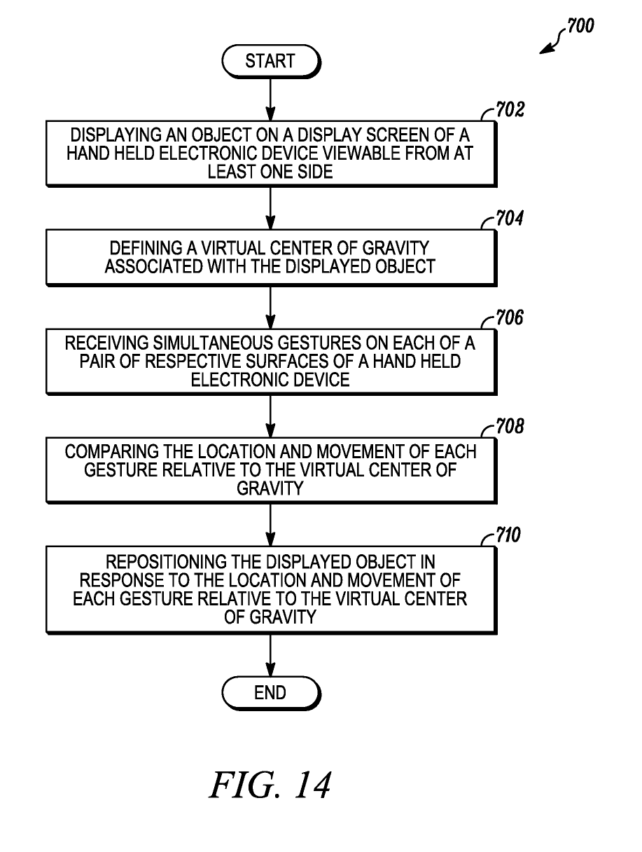

FIG. 14 illustrates a flow diagram of a method 700 of performing a dual sided gesture on a hand held electronic device, in accordance with at least one embodiment of the present invention. The method 700 includes displaying 702 an object on a display screen of the hand held electronic device viewable from at least one side of the hand held electronic device. A virtual center of gravity associated with the displayed object is then defined 704. Simultaneous gestures are then received 706, which track the position and movement of an end of a pointer on each of a pair of respective surfaces of the hand held electronic device, each surface having a corresponding touch sensitive input. The location and movement of each gesture is then compared 708, relative to the defined virtual center of gravity. The displayed object is then repositioned 710 in response to the location and movement of each gesture relative to the defined virtual center of gravity.

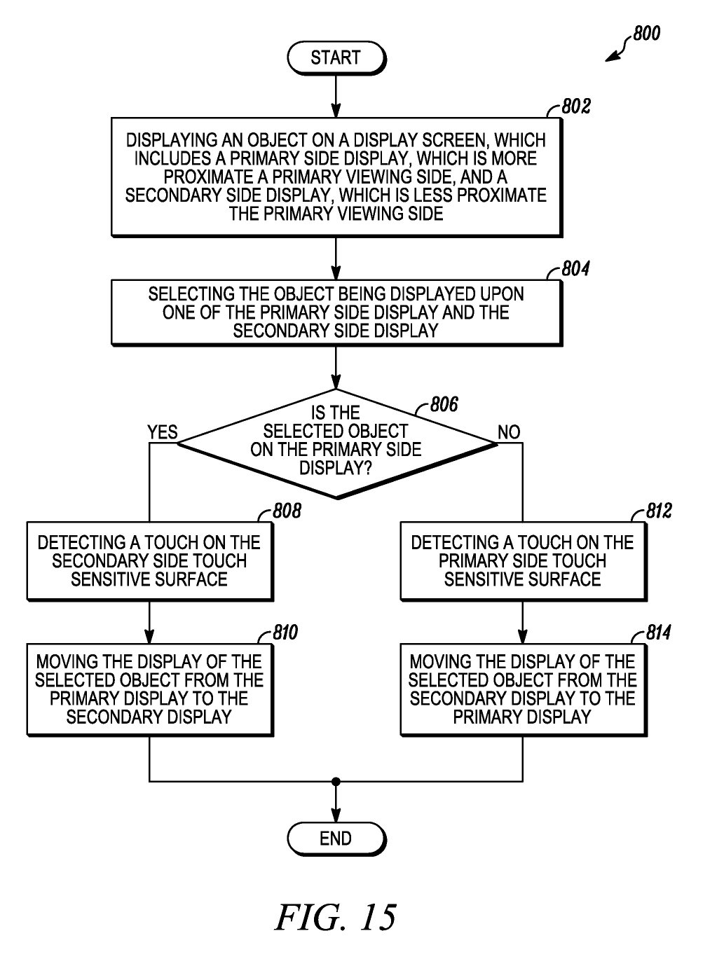

FIG. 15 illustrates a further flow diagram of a method 800 of performing a dual sided gesture on a hand held electronic device, in accordance with at least one embodiment of the present invention. The method 800 includes displaying 802 an object on a display screen, where the display screen includes multiple layered transparent displays including at least a primary side display, which is more proximate a primary viewing side, which is intended to be facing toward a primary user during usage, and a secondary side display, which is less proximate the primary viewing side, upon one of which the object is displayed. The object being displayed upon one of the primary side display and the secondary side display is then selected 804. A determination 806 is then made as to whether the selected object in on the primary side display or the secondary side display. Upon a determination that the selected object is being displayed upon the primary side display, a touching of the secondary side touch sensitive surface is detected 808, and upon detection results in the display of the object being moved 810 from the primary side display to the secondary side display. Upon a determination that the selected object is being displayed upon the secondary side display, a touching of the primary side touch sensitive surface is detected 812, and upon detection results in the display of the object being moved 814 from the secondary side display to the primary side display.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of performing a dual sided gesture on respective touch sensitive surfaces of a hand held electronic device, the method comprising:
displaying an object on a display screen of the hand held electronic device viewable from at least one side of the hand held electronic device;
defining a virtual center of gravity associated with the displayed object;
receiving simultaneous gestures tracking the position and movement of an end of a pointer on each of a pair of respective surfaces of the hand held electronic device, each surface having a corresponding touch sensitive input;
comparing the location and movement of each gesture relative to the defined virtual center of gravity; and
repositioning the displayed object in response to the location and movement of each gesture relative to the defined virtual center of gravity.

2. A method in accordance with claim 1, wherein the virtual center of gravity is defined by the center of a starting point of each of the two simultaneous gestures on the respective touch sensitive surfaces.

3. A method in accordance with claim 1, wherein the virtual center of gravity is defined by the center of an ending point of each of the two simultaneous gestures on the respective touch sensitive surfaces.

4. A method in accordance with claim 1, wherein the virtual center of gravity is defined by the center of the display screen of the hand held electronic device upon which the object is displayed.

5. A method in accordance with claim 1, wherein a detected difference in direction of movement between the two gestures relative to the virtual center of gravity will produce a rotation in the object on the display screen in a direction consistent with detected difference from a perspective of a primary viewing side of the display screen.

6. A method in accordance with claim 5, wherein the virtual center of gravity serves as an anchor for one point of the displayed object, relative to lateral movement with respect to displaying the object on the display screen, when the two gestures have a detected difference in direction of movement.

7. A method in accordance with claim 1, wherein the respective surfaces include a primary side intended to be facing toward the primary user during usage and a secondary side intended to be facing away from the primary user during usage, and the method further comprising:
receiving a gesture tracking the position and movement of an end of a pointer on only the surface corresponding to the secondary side of the hand held electronic device, that has a corresponding touch sensitive input;
moving a display position of the displayed object, laterally relative to the display screen, an amount corresponding to the detected distance and direction of movement of the end of the pointer relative to the surface of the secondary side of the hand held electronic device.

8. A method in accordance with claim 7, wherein moving a display position of the displayed object includes moving a displayed object including a grouping of a plurality of elements, wherein as the display position of the grouping of the plurality of elements is moved, a different one of the grouping of the plurality of elements is positioned so as to coincide with a predetermined point of prominence.

9. A method in accordance with claim 8, wherein as the different one of the grouping of the plurality of elements is positioned so as to coincide with the predetermined point of prominence, the current one of the grouping of the plurality of elements that coincides with the predetermined point of prominence is at least one of enlarged or highlighted.

10. A method in accordance with claim 1, wherein the respective surfaces include a primary side intended to be facing toward the primary user during usage and a secondary side intended to be facing away from the primary user during usage, and the method further comprising:
receiving a selection gesture tracking the position of an end of a pointer on only the surface corresponding to the primary side of the hand held electronic device, that has a corresponding touch sensitive input;
initiation an action based upon the selection of a displayed object at the location of the selection gesture.

11. A method in accordance with claim 10, wherein the selection gesture includes tapping a single location.

12. A method of performing a dual sided gesture on respective touch sensitive surfaces of a hand held electronic device, the method comprising:
displaying an object on a display screen, where the display screen includes multiple layered transparent displays including at least a primary side display, which is more proximate a primary viewing side, which is intended to be facing toward a primary user during usage, and a secondary side display, which is less proximate the primary viewing side, upon one of which the object is displayed;
selecting the object being displayed upon one of the primary side display and the secondary side display; and
where upon selection of an object being displayed upon the primary side display, touching the secondary side touch sensitive surface will result in the display of the object being moved from the primary side display to the secondary side display; and
where upon selection of an object being displayed upon the secondary side display, touching the primary side touch sensitive surface will result in the display of the object being moved from the secondary side display to the primary side display.

13. A method in accordance with claim 12, wherein objects being displayed on each of the primary side display and the secondary side display can be simultaneously seen via the primary viewing side, and the method further comprising:
touching one of the primary side touch sensitive surface and the secondary side touch sensitive surface;
where upon touching the primary side touch sensitive surface, at least one of the intensity of the elements displayed on the primary side display is increased, and the intensity of the elements displayed on the secondary side display is decreased; and
where upon touching the secondary side touch sensitive surface, at least one of the intensity of the elements displayed on the secondary side display is increased, and the intensity of the elements displayed on the primary side display is decreased.

14. A hand held electronic device comprising:
a display screen for displaying an object viewable from at least one side of the hand held electronic device;
a pair of touch sensitive interfaces corresponding to opposite sides of the hand held electronic device adapted for tracking the position and movement of an end of a pointer on each of the respective touch sensitive interfaces; and
a user input controller including
an object selection module for selecting an object being displayed on the display screen; and
an object management module for detecting one or more gestures detected via one or more of the pair of touch sensitive interfaces and repositioning a selected object based upon the one or more gestures, where the object management module is adapted for defining a virtual center of gravity for a selected object, detecting a simultaneous gesture on each of the pair of touch sensitive interfaces, and repositioning the displayed object in response to the location and movement of each gesture relative to the defined virtual center of gravity.

15. A hand held electronic device in accordance with claim 14, wherein the display screen includes a transparent display viewable from opposite sides of the hand held electronic device.

16. A hand held electronic device in accordance with claim 15, wherein the display screen is part of a display module including a pair of transparent displays, which at least partially overlap in a direction perpendicular to an image plane of each of the transparent displays, where images displayed on each of the displays can be viewed simultaneously from at least one of the sides of the hand held device.

17. A hand held electronic device in accordance with claim 15, wherein one of the opposites sides of the hand held electronic device from which the transparent display is viewable includes a primary viewing side, which is intended to be facing toward a primary user of the hand held electronic device during usage, and a secondary viewing side, which is intended to be facing away from the primary user of the hand held electronic device during usage.

18. A hand held electronic device in accordance with claim 14, wherein the pair of touch sensitive interfaces includes a capacitive touch sensor array.

19. A hand held electronic device in accordance with claim 14, wherein the pair of touch sensitive interfaces includes a resistive touch sensor array.

20. A hand held electronic device in accordance with claim 14, wherein the user input controller includes a processor, and one or more of the object selection module and the object management module includes one or more sets of prestored instructions for execution by the processor.
